(19) United States
(12) Patent Application Publication
(10) Pub. No.: US 2004/0123958 A1
(43) Pub. Date: Jul. 1, 2004

(54) Window covering cord holder

(76) Inventor: Deborah A. Krug, Andalusia, PA (US)

Correspondence Address: John F. Letchford, Klehr, Harrison, Harvey, Branzburg & Ellers, 260 South Broad Street, Philadelphia, PA, 19102, US

(21) Appl. No.: 10/625,675

(22) Filed: Jul. 23, 2003

Related U.S. Application Data
(60) Provisional application No. 60/401,605, filed on Aug. 7, 2002.

(51) Int. Cl. E06B 9/38

(52) U.S. Cl. 160/178.1 R

(57) ABSTRACT

A window covering cord holder that suspends window covering cords a safe distance above the reach of infants and small children. The holder includes first and second cooperating members, at least one of which carries decorative matter that is visible at a substantial distance from the window covering. The first and second members are easily placed about and grippingly engage proximal and distal portions of a catenary loop of a window covering cord whereby the height of the loop may be easily adjusted to a desired elevation above the floor.

### CROSS-REFERENCE TO RELATED APPLICATION

This application claims the benefit of U.S. Provisional Patent Application Serial No. 60/401,605, entitled “STICK 'EM UP” WINDOW BLIND CORD HOLDER filed Aug. 7, 2002.

### FIELD OF THE INVENTION

The present invention relates in general to safety apparatus for cords for window coverings such as blinds and the like, and in particular to a decorative and easily adjustable window covering cord holder that prevents strangling or other harm to infants and young children.

### BACKGROUND OF THE INVENTION

A cord is typically coupled to a window covering for adjusting the vertical position of the covering in order to expose a desired amount of the window shielded thereby. In conventional Venetian blind window coverings, for example, when a blind is raised to expose a window, the associated adjustment cord often extends downwardly to a position at or slightly above floor height. Conversely, when the blind is lowered the cord may be disposed as high as several feet above floor height.

Window covering cords frequently comprise two strands that are usually attached each other at their lower ends such as by a knot or the like. Window cords present an invitation to play to infants and small children. Young children are not generally aware of the dangers presented by such cords. For example, a double-stranded cord may function as a noose if a small child places his or her head between the cords and presses downwardly on the cord.

The dangers presented by dangling cords are especially great when a window covering is raised and its cord reaches to, or close to, floor level. In order to prevent harm to small children and to avoid the unattractive appearance of dangling cords, a variety of cord holders have been proposed for suspending the cord well above the floor when the window covering is raised. Examples of such window covering cord holders are shown in U.S. Design Pat. Nos. Des. 329,350 and Des. 389,731. In order to adjust the height of the window covering using a typical window covering cord holder, which may be mounted to the wall adjacent the window or suspended from the cord itself, the user must first unwind the cord from the holder. The user then raises or lowers the window covering to the desired height and rewinds the cord onto the holder. This process is time-consuming and therefore a user does not always bother to take the time to rewind the cord on the holder after the window covering has been adjusted. Moreover, if not performed correctly, i.e., if the user carelessly rewinds the cord back onto the holder, or if the holder does not have sufficient capacity to support more than a few coils of the cord, the cord may become unwrapped from the holder and again dangle at or near floor height.

Many window covering manufacturers now commonly include cord holders with the window coverings that are sold to consumers. Such cord holders are typically fastened to the wall adjacent the window covering and function as described above. Although useful for their intended purpose, wall-mounted cord holders suffer from several disadvantages in addition to those enumerated above. In many cases, the cord holder must be mounted to the wall using hand tools and hardware such as a drill, a screwdriver, a screw and a wall anchor. Many consumers have neither the skill nor the desire to take the time and effort necessary to properly mount the device to the wall. As a consequence, many consumers do not bother to use the holder. And, even in situations where consumers have the requisite skill to mount the device, the holder is often an unattractive piece of metal or molded plastic. Because of this, many consumers choose not to mount the device for reason that they believe that it detracts from the aesthetic appearance of the wall. In any of the foregoing situations, whether mounted to the wall or not, the cord is left dangling and represents a danger to young children.

Alternatives to wall-mounted cord hangers are also known. For example, U.S. Pat. No. 4,909,298 provides a window covering cord safety device comprising first and second members respectively connected to first and second strands of a typical window covering cord. The first and second members are joined to one another by readily releasable means such as low-strength magnets or Velcro®. If a child gets trapped between the strands of the cord, the child's weight separates the first and second members, thereby freeing the child from the cord. While useful as a safety device, it is not a decorative item and still represents an attraction to small children when the cord is left to dangle at or near floor height. That patent also optionally provides for magnetic attachment of the device to the window covering frame. With this feature the device may function substantially as a releasable “wall mounted” cord holder of the type described above, i.e., one where the user must wind coils of the cords around the device to suspend the cord up and out of the reach of small children. However, as with conventional wall mounted cord hangers, if the user carelessly rewinds the cord back onto the holder, or if the holder does not have sufficient capacity to support more than a few coils of the cord, the cord may become unwrapped from the holder and again dangle at or near floor height.

U.S. Pat. No. 4,635,698 discloses a device for equalizing the strands a window blind cord such that the cord will raise and lower the blind without skewing of the blind's slats. The device offers no mechanism or capability for selectively suspending the cord at a safe height with regard to small children when the blind is raised to expose a window.

U.S. Pat. No. 4,049,357 and U.S. Design Pat. No. 247,345 disclose cord coupling devices for lanyard cord loops of fixed length and U.S. Pat. No. 6,305,053 provides a cord lock. A common feature of these devices is that the positions of the devices may be adjusted relative to the cords that they engage. However, there is no suggestion in these patents that the devices described therein can be used to adjust the height of a window covering cord relative to a floor.

Additionally, none of the devices in any of the foregoing patents are believed to be purposefully designed to be both functional and aesthetically pleasing. That is, none are dedicated both to safely suspending window covering cords from the reach of small children and to prominently displaying decorative matter that can be seen at a substantial distance from a window covering.

An advantage exists, therefore, for an easy to use and attractive cord holder for window coverings such as blinds or the like that does not require wall mounting and that safely keeps dangerous cords from the reach of small children.

### SUMMARY OF THE INVENTION

The present invention provides a decorative device that is suspended by a window covering cord and that operates to suspend the window covering cord a safe distance above the reach of infants and small children. The device preferably comprises first and second cooperating members, at least one of which carries decorative matter that is clearly visible from a substantial distance, e.g., several feet, from the window covering. The first and second members may be integrally, yet resiliently, connected to one another. Alternatively, they may be discrete members pivotally or hingedly connected to one another. They may also be discrete members that are releasably connectable to one another via quick-release means such as Velcro® or the like. Regardless of construction, the first and second members are easily placed about and grippingly engage proximal and distal portions of a catenary loop of a window covering cord whereby the height of the loop may be easily adjusted to a desired elevation above the floor.

Additionally, the device may include means for releasably attaching decorative matter to either or both of the first and second members, whereby different types of decorative matter may be easily interchanged and whereby the device may cast different visual impressions to an observer.

Other details, objects and advantages of the present invention will become apparent as the following description of the presently preferred embodiments and presently preferred methods of practicing the invention proceeds.

### BRIEF DESCRIPTION OF THE DRAWINGS

The invention will become more readily apparent from the following description of preferred embodiments thereof shown, by way of example only, in the accompanying drawings wherein:

FIG. 1 is perspective and exploded view, with certain elements omitted for clarity of illustration, of a window covering cord holder according to the present invention;

FIG. 2 is a front view of a window covering cord holder according to the present invention in operative contact with a window covering cord;

FIG. 3 is a view of the window covering cord holder according to the present invention as seen from line III-III of FIG. 2; and

FIG. 4 is a distant view of a window covering cord holder according to the present invention mounted to the cord of an opened window covering.

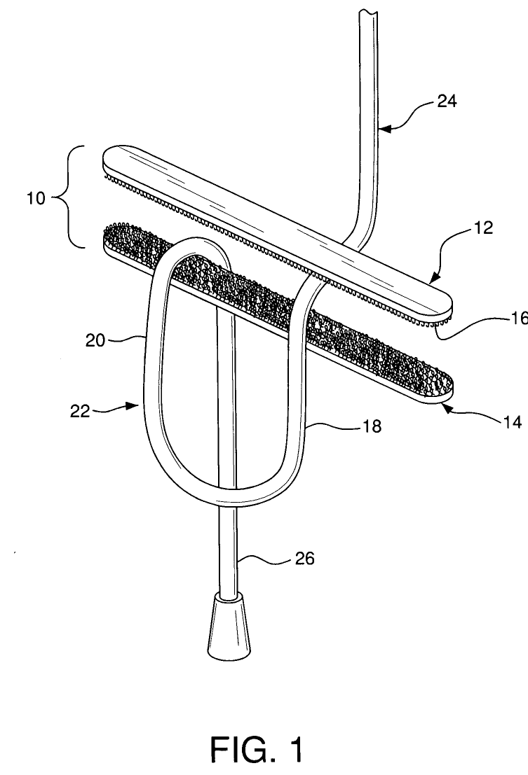

### DETAILED DESCRIPTION OF THE INVENTION

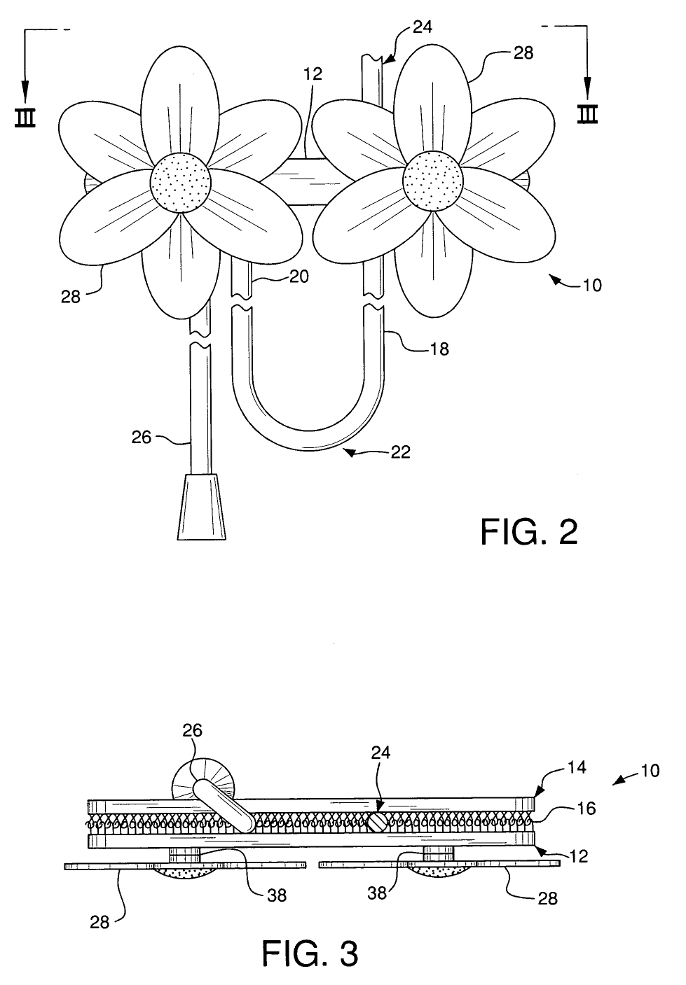

Referring to the drawing figures, wherein like or similar references indicate like or similar elements throughout the several views, there is shown a window covering cord holder according to the present invention identified generally by reference numeral 10. Holder 10 comprises a first member 12, a second member 14 and means 16 for connecting the first and second members and for urging the first and second members into firm yet slidable gripping engagement with proximal 18 and distal 20 portions of a catenary loop 22 formed into a window covering cord 24. As will be more fully appreciated by reference to FIGS. 2 and 3, described below, such a construction enables window covering cord holder 10 to be suspended by the window covering cord 24 while the holder simultaneously suspends the catenary loop 22 and distal end 26 of the cord at desired heights above a floor. Although for simplicity of illustration cord 24 is shown as having a single strand, it will be understood that, as is conventional, the cord may be comprised of two or more strands. And, in the context of the present invention, cord 24 is formed into a catenary loop 22 when the distal end 26 of the cord is raised upwardly whereby the cord assumes a generally U-shaped configuration.

First and second members 12,14 may be fabricated from flexible, semi-rigid or rigid materials. According to a presently preferred embodiment, members 12 and 14 are separate and discrete members that are releasably connectable to one another via quick-release means 16. As illustrated, such means may include, for example, low strength magnets or hook and loop type fastening means such as Velcro® or the like. Alternatively, first and second members 12,14 may be discrete members pivotally or hingedly connected to one another at first ends thereof with optional latch, clasp or clip means being provided at their corresponding second ends in order to releasably enclose the first and second members about the proximal 18 and distal 20 portions of the catenary loop 22 formed into cord 24. Still further, the first and second members 12,14 may be integrally, yet resiliently, connected to one another.

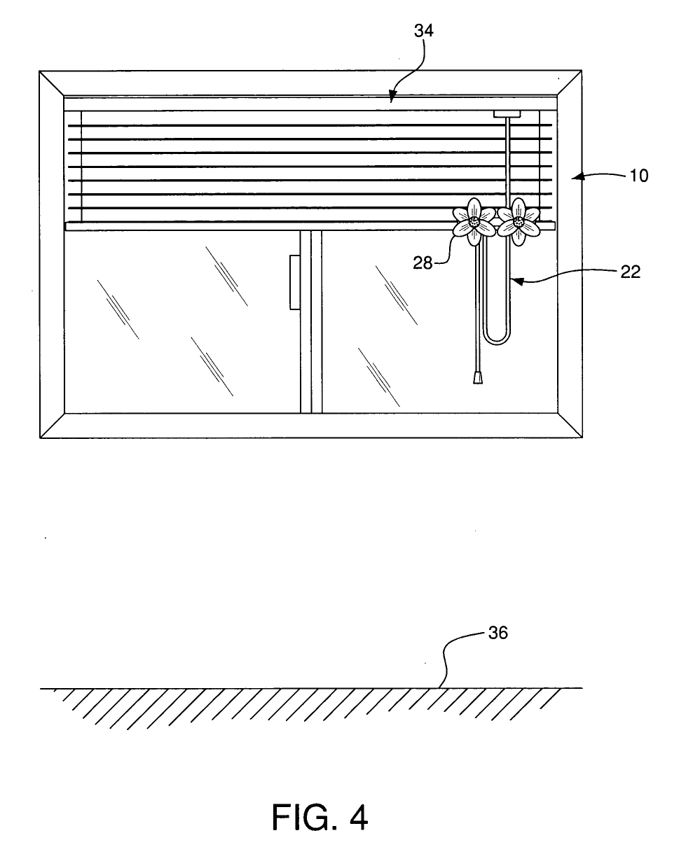

To operate holder 10, for instance when a user wishes to raise a window covering such as a blind or the like (reference numeral 34 in FIG. 4), the user first pulls cord 24 downwardly a sufficient distance to raise the window covering to a desired height. Then, the user grasps the distal or free end 26 of the dangling cord 24 and raises it such that catenary loop 22 is formed at a desired height above the floor (reference numeral 36 in FIG. 4). While holding the cord in a catenary loop formation, the user separates first and second members 12,14 of holder 10 a sufficient distance to receive both the proximal 18 and distal 20 portions of the catenary loop 22. The user then encloses first and second members 12,14 about cord 24 such that the members come into gentle gripping engagement with the proximal and distal portions of the catenary loop in the manner shown in FIG. 3. Thereafter, the height of holder 10 may be easily adjusted by holding the cord 24 either above or below the holder and sliding the holder upwardly or downwardly as desired. Similarly, the size of catenary loop 22 and/or the height of the distal end 26 of cord 24 may be adjusted by grasping the holder 10 while slidably manipulating any portion of cord 24 to achieve the desired effect.

As depicted in FIGS. 2 and 3, in addition to first and second members 12,14 and connecting means 16, holder 10 further includes decorative matter 28 carried by at least one of the first and second members 12,14. Decorative matter 28 may be any two-dimensional or three-dimensional indicia, design or object that is of sufficient size to at least substantially or even entirely conceal first and second members 12,14. For example, although graphically embodied as flowers, decorative matter 28 may assume the form of any seasonal, holiday, animal, plant, vegetable, sports, vocational, avocational or other theme of interest to the user. Moreover, as is reflected in FIG. 4, in order for holder 10 to effectively function as a prominent room accent, decorative matter 28 should be sufficiently large so as to be clearly visible by a user situated at a substantial distance, e.g., several feet, from window covering 34.

As most clearly seen in FIG. 3, the window covering cord holder 10 of the present invention includes means 38 for connecting the decorative matter 28 to at least one of the first and second members 12,14. Means 38 may comprise permanent connecting means such as high strength adhesive or heat bonding material, stitching, rivets or the like. Alternatively, connecting means 38 may comprise means for releasably attaching the decorative matter including, without limitation, any conventional hook and loop type fastening means, low-tack reusable adhesives, snap connectors, slide connectors or low-strength magnets. Releasable connecting means enable any conceivable type of decorative matter 28 to be interchangeably carried by holder 10 whereby the holder may be easily adapted to assume a variety of visual appearances to satisfy a user's tastes or to complement particular design themes for different rooms.

Although the invention has been described in detail for the purpose of illustration, it is to be understood that such detail is solely for that purpose and that variations can be made therein by those skilled in the art without departing from the spirit and scope of the invention as claimed herein.

What is claimed is:

1. A window covering cord holder for use in adjusting the height of a window covering cord that is operable to manipulate a window covering and capable of being formed into a catenary loop, said window covering cord holder comprising:
a first member;
a second member;
decorative matter carried by at least one of said first and second members, said decorative matter being of sufficient size to substantially conceal said first and second members; and
means for connecting said first and second members and for urging said first and second members into slidable engagement with proximal and distal portions of a catenary loop formed into the window covering cord such that said window covering cord holder is suspendable by the window covering cord and the catenary loop and a distal end of the window covering cord is suspendable at a desired height above a floor by said window covering cord holder.

2. The window covering cord holder of claim 1 wherein said means connecting said first and second members comprise hook and loop type fastening means carried by said first and second members.

3. The window covering cord holder of claim 1 further comprising means for releasably connecting said decorative matter to at least one of said first and second members.

4. The window covering cord holder of claim 3 wherein said decorative matter is three-dimensional.

5. A method for suspending a window covering cord above a floor, said method comprising the steps of:
providing a window covering cord holder comprising first and second cooperating members wherein at least one of the first and second members carries decorative matter of sufficient size to substantially conceal the first and second members;
pulling a window covering cord downwardly to raise a window covering to a desired height;
grasping a distal end of the cord and raising it such that a catenary loop having a proximal portion and distal portion is formed in the cord;
holding the cord in a catenary loop formation; and
placing the first and second members of the window covering cord holder into gripping engagement with both the proximal and distal portions of the catenary loop whereby the window covering cord holder is suspended by the cord and the catenary loop and distal end of the cord are suspended by the window covering cord holder.

6. The method of claim 5 further comprising slidably adjusting the height of the window covering cord holder with respect to the window covering cord.

7. The method of claim 5 further comprising slidably adjusting the size of the catenary loop.
